(19) United States
(12) Patent Application Publication
(10) Pub. No.: US 2009/0286144 A1
(43) Pub. Date: Nov. 19, 2009

(54) Battery case for carrying rechargeable battery

(76) Inventor: Ping-Hsien Wu, Taichung County (TW)

Correspondence Address: Wu, Ping-Hsien, P.O. Box 44-2049, Taipei, 10668, TW

(21) Appl. No.: 12/153,289

(22) Filed: May 16, 2008

(51) Int. Cl. H01M 2/10

(52) U.S. Cl. 429/100

(57) ABSTRACT

A battery case includes a space for receiving a rechargeable battery therein and at least one contact point is connected to one sidewall of the space. A circuit is connected with the at least one contact point and a switch located on outside of the battery case is electrically connected with the circuit. A display device is electrically connected with the circuit. When the rechargeable battery is received in the space, the display device shows the user the power level of the rechargeable battery.

### BACKGROUND OF THE INVENTION

(1) Field of the Invention

The present invention relates to a battery case for carrying a rechargeable battery and the device displays the status of the battery.

(2) Description of the Related Art

Rechargeable battery is widely used for electronic appliances such as cellular phones, digital cameras, laptops and the like, many users have two identical rechargeable batteries for their electronic appliances, the second rechargeable battery is usually carried with the users in case of low power of the first battery in use. However, the conventional rechargeable battery is exclusive in shape and size and only cooperated with the electronic appliance. In other words, different brands of manufacturers and models develop different shapes and sizes of the rechargeable battery, so that the rechargeable batteries can not be used for other electronic appliances. Once the users purchase another model of the electronic appliance, the old rechargeable batteries are useless and eventually discarded.

Besides, the second rechargeable battery usually is put in the user's bag and the rechargeable battery includes two metal contact terminals which might be touched with metal items, such as keys, in the bag and a short of the circuit of the rechargeable battery may cause. Usually, the users will not purchase the same model of the electronic appliances again and probably purchase a latest model which cannot use the rechargeable batteries of the previous electronic appliance. Therefore, a certain amount of the batteries are discarded everyday. On the contrary, if the electronic appliance functions well and only the rechargeable battery is damaged, the users will purchase a new rechargeable battery only. Therefore, how to protect the rechargeable battery when carrying it in the bag is an important certain.

Furthermore, the user cannot check the power level of the rechargeable battery before the rechargeable battery is not yet installed to the electronic appliance. Sometimes, the user forgot the second rechargeable battery has not yet be fully recharged so that when the power of the first battery runs out, the second rechargeable battery is at a low level of power and cannot function as expected.

The present invention intends to provide a battery case that receives the rechargeable battery therein and the battery case includes a circuit which checks and displays the level of power of the rechargeable battery so that the users can easily acknowledge the status of the rechargeable battery. Besides, when the electronic appliance cannot be used, the users are acknowledged that the rechargeable batteries are functioned normally by the data shown from the present invention.

### SUMMARY OF THE INVENTION

The present invention relates to a battery case which comprises a space for receiving a rechargeable battery therein and at least one contact point is connected to at least one sidewall of the space. A circuit is connected with the at least one contact point and a switch located on outside of the battery case is electrically connected with the circuit. A display device is electrically connected with the circuit and displays the power level of the rechargeable battery in the battery case.

The primary object of the present invention is to provide a battery case which shows the power level of the battery in the battery case.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the battery case of the present invention;

FIG. 2 is a perspective view to show the second embodiment of the battery case of the present invention;

FIG. 3 is a perspective view to show the third embodiment of the battery case of the present invention, and

FIG. 4 is a perspective view to show the fourth embodiment of the battery case of the present invention.

### DETAILED DESCRIPTION OF THE PREFERRED EMBODIMENTS

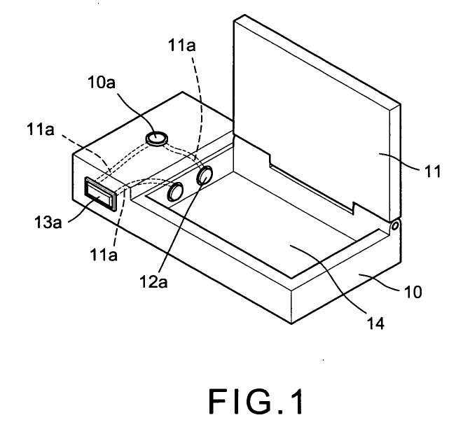

Referring to FIG. 1, the battery case 10 of the present invention is a rectangular case which comprises a space 14 defined therein and a cover 11 is and optionally connected to the battery case 10 so as to close the space 14. The space 14 is defined by four sidewalls and two contact points 12a are connected to one of the sidewalls. A circuit is connected with the contact points 12a by wires 11a. A switch 13a is located on outside of the battery case 10 and electrically connected with the circuit. A display device 10a is electrically connected with the circuit. In this embodiment, the circuit is an illumination circuit and the display device 10a is a light. When a rechargeable battery (not shown) is received in the battery case 10 and the terminals of the rechargeable battery are in contact with the contact points 12a, the light of the display device 10a shows in a certain way to acknowledge the user the power level of the rechargeable battery.

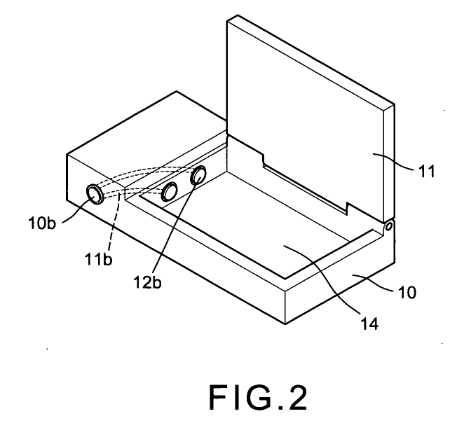

As shown in FIG. 2 which is a second embodiment of the present invention, wherein the battery case 10 of the present invention is a rectangular case which comprises a space 14 defined therein and a cover 11 is pivotably and optionally connected to the battery case 10 so as to close the space 14. The space is defined by four sidewalls and two contact points 12b are connected to one of the sidewalls. A circuit is connected with the contact points 12b by wires 11b. An output device 10b is located on outside of the battery case 10 such that another electronic appliance (not shown) can be electrically connected with the output device 10b.

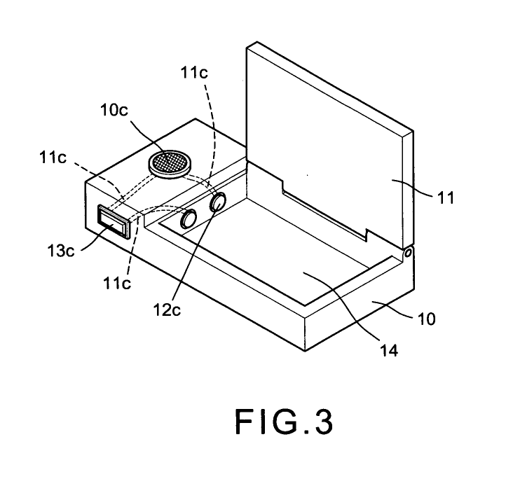

FIG. 3 shows a third embodiment of the present invention wherein the battery case 10 of the present invention is a rectangular case which comprises a space 14 defined therein and a cover 11 is and optionally connected to the battery case 10 so as to close the space 14. The space 14 is defined by four sidewalls and two contact points 12c are connected to one of the sidewalls. A circuit is connected with the contact points 12c by wires 11c. A switch 13c is located on outside of the battery case 10 and electrically connected with the circuit. A display device such as a speaker 10c is electrically connected with the circuit. In this embodiment, when a rechargeable battery (not shown) is received in the battery case 10 and the terminals of the rechargeable battery are in contact with the contact points 12c, the speaker 10c generates certain sound to acknowledge the user the power level of the rechargeable battery.

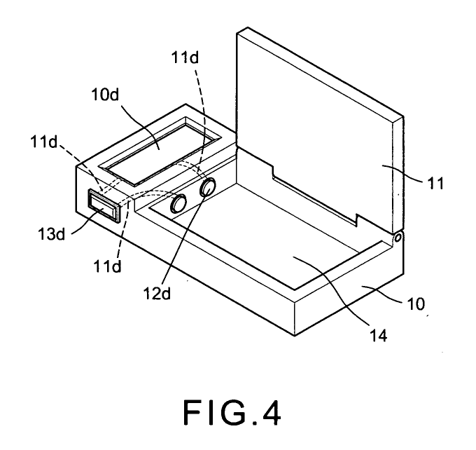

FIG. 4 shows a fourth embodiment of the present invention wherein the battery case 10 of the present invention is a rectangular case which comprises a space 14 defined therein and a cover 11 is and optionally connected to the battery case 10 so as to close the space 14. The space 14 is defined by four sidewalls and two contact points 12d are connected to one of the sidewalls. A circuit is connected with the contact points 12d by wires 11d. A switch 13d is located on outside of the battery case 10 and electrically connected with the circuit. A display device such as a radio 10d is electrically connected with the circuit. In this embodiment, when a rechargeable battery (not shown) is received in the battery case 10 and the terminals of the rechargeable battery are in contact with the contact points 12d, the radio 10d can be activated and if the radio 10d works, this means the rechargeable battery has a certain level power.

By operating the switch 13a/13c/13d, the circuit can be connected or cut.

The rechargeable battery can be protected within the battery case 10 and the power level of the rechargeable battery can be displayed immediately.

While we have shown and described the embodiment in accordance with the present invention, it should be clear to those skilled in the art that further embodiments may be made without departing from the scope of the present invention.

What is claimed is:

1. A battery case comprising:
a space defined therein which is defined by at least one sidewall, at least one contact point connected to the at least one sidewall, a circuit connected with the at least one contact point, a switch located on outside of the battery case and electrically connected with the circuit, and a display device electrically connected with the circuit.

2. The battery case as claimed in claim 1, wherein a cover is connected to the battery case and closes the space.

3. The battery case as claimed in claim 1, wherein the circuit is an illumination circuit.

4. The battery case as claimed in claim 1, wherein the display device is a light.

5. The battery case as claimed in claim 1, wherein the display device is a speaker.

6. The battery case as claimed in claim 1, wherein display device is a radio.

7. A battery case comprising:
a space defined therein which is defined by at least one sidewall, at least one contact point connected to the at least one sidewall, a circuit connected with the at least one contact point, an output device located on outside of the battery case and adapted to be electrically connected with another electronic appliance.

8. The battery case as claimed in claim 7, wherein a cover is connected to the battery case and closes the space.
